(19) United States
(12) Patent Application Publication
(10) Pub. No.: US 2012/0297131 A1
(43) Pub. Date: Nov. 22, 2012

(54) Scheduling-Policy-Aware DRAM Page Management Mechanism

(76) Inventors: Jaewoong Chung, Bellevue, WA (US); Arkaprava Basu, Bellevue, WA (US)

(21) Appl. No.: 13/112,617

(22) Filed: May 20, 2011

(51) Int. Cl. G06F 12/00

(52) U.S. Cl. 711/105; 711/E12.001

(57) ABSTRACT

Memory controller page management devices, systems, and methods are disclosed in which a memory controller is configured to access memory in response to a memory access request by applying a scheduler-aware page management policy to at least one memory page based in the memory based on row buffer status information for the pending memory access requests scheduled in a current cycles.

### BACKGROUND OF THE INVENTION

1. Field of the Invention

The present invention relates in general to the design and use of integrated circuit memory. In one aspect, the present invention relates to memory access controllers, memory page management policies, and related systems and methods for operating a dynamic random access memory (DRAM).

2. Description of the Related Art

In typical computer systems, dynamic random access memory (DRAM) is used for system memory, and is organized into a number of memory banks with each memory bank containing multiple memory pages. To control DRAM access, memory controllers are used to manage the flow of data to/from a memory, and may be implemented in a Northbridge chip (integrated circuit (IC)) or within a central processing unit (CPU) chip (in order to reduce memory latency). In general, DRAM memory controllers contain logic for reading data from and writing data to DRAM modules and for refreshing the DRAM modules which are organized to support multiple parallel transactions to different DRAM banks from multi-core devices. However, there can be significant performance limitations created when multiple cores request read/write access to off-chip DRAM memory arising from a variety of factors which create delay or latency in accessing dynamic memory. For example, DRAM designs typically include a DRAM row buffer for buffering stored data, and if the requested data is already stored in the DRAM row buffer of the bank the request is accessing, the memory access request can be served with minimal access latency by retrieving the data from the row buffer. However, if the DRAM row buffer of the bank does not have any data, the memory access request misses the row buffer, and a row miss takes much longer to serve than a row hit since the requested data must first be transferred from the DRAM cell arrays to the DRAM row buffer (i.e., activating the row). In addition, if the row buffer has data other than the requested data, the memory access request conflicts with the row buffer, and this causes the greatest access latency since the current data of the row buffer has to be transferred back to the DRAM cell arrays (i.e., closing the page) before the requested data can be uploaded to the row buffer to serve the memory access request.

To reduce memory access times and latency, memory controllers can be configured with a page management policy to leave open a memory page after a memory access, such as by closing a memory page only if required to service a pending memory access request targeting a new memory page or to perform memory maintenance commands, such as auto-refresh or self-refresh, as examples. Page management policies which leave open a memory page may work for certain memory applications since processing time is saved by not closing the memory page before the next memory access, but there are performance tradeoffs with such policies, including processing time penalties that are incurred with row conflicts, as well as additional power consumption associated with keeping the memory page open after an access. While page management policies have been proposed for improving the decision about whether to open or close a page before the next request, these typically are designed to only work with the traditional FRFCFS (first row hit, then first-come first-serve) scheduling policies which are oblivious to the possible presence of multiple concurrent request streams with varying characteristics from multi-core applications, and are thus prone to yielding non-optimal overall system performance.

### SUMMARY OF EMBODIMENTS OF THE DISCLOSURE

Broadly speaking, the present disclosure describes a memory management apparatus and method of operation in which a page management policy is aware of the scheduling policy and uses information about the next request to be scheduled when deciding whether to open or close a row buffer, thereby providing page management outcomes that match the memory scheduler's decision for performance improvement. For example, instead of blindly assuming FRFCFS scheduling policies, the page manager asks the scheduler about the next request to be scheduled and decides either to open or close the row buffer accordingly. This way, the page manager and the scheduler can make coordinated decisions to yield low DRAM access latency.

In selected example embodiments, a memory system is discloses have a memory controller that is configured to access memory in response to a memory access request by applying a scheduler-aware page management policy to at least one memory page based in the memory based on row buffer status information for the pending memory access requests scheduled in a current cycle. The memory controller may include a memory controller queue for storing pending memory access requests from a plurality of concurrent request streams with varying characteristics. In addition, the memory controller may include a scheduler for applying a predetermined scheduling policy (e.g., Adaptive per-Thread Least-Attained-Service) to the plurality of concurrent request streams to select a next scheduled memory access request. In selected embodiments, the scheduler is configured to tentatively select the next scheduled memory access request without removing the next scheduled memory access request from the memory controller queue, and to notify the page manager unit of the next scheduled memory access request. The memory controller may also include an open page table for storing the row buffer status information for the pending memory access requests scheduled in a current cycle. Finally, the memory controller may include a page manager for collaborating with the scheduler to determine if a row conflict exists between the next scheduled memory access request and a pending memory access request based on row buffer status information stored in the open page table. The page manager may be configured to tentatively update the open page table to keep open a row buffer for a page at a predetermined memory bank associated with a pending memory access request. In addition, the page manager may be configured to apply a leave open page management policy to the open page table for a row buffer of a page at a predetermined memory bank associated with a pending memory access request if there is no row conflict with the next scheduled memory access request to the predetermined memory bank. The page manager may also configured to instruct the open page table to close a row buffer of a page at a predetermined memory bank associated with a pending memory access request if there is a row conflict with the next scheduled memory access request to the predetermined memory bank.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a simplified circuit block diagram of an example processor system that may be configured according to various embodiments of the present disclosure;

FIG. 2 shows a simplified block diagram of an example memory controller in which a page management policy uses a non-aware scheduling policy;

FIG. 3 shows in simplified block diagram form an example memory controller hardware for providing scheduling-policy-aware DRAM page management in accordance with selected embodiments of the present disclosure; and

FIG. 4 illustrates a flow diagram for the operation of a scheduling-policy-aware DRAM page management in accordance with selected embodiments of the present disclosure.

### DETAILED DESCRIPTION

A memory management apparatus and method of operation are described for efficiently managing memory accesses by making the page manager aware of the existing scheduling policy to assist the page manager to make page management decisions that match the memory scheduler's decision algorithms and thereby improve performance by reducing row conflicts that can increase memory access latency. In selected example embodiments, a memory controller includes a page manager unit or other hardware and/or software for implementing a page management policy that is configured to communicate with the scheduler about the next memory access request to be scheduled when deciding whether to open or close a row buffer for a pending memory access request. By storing the page status in a page status table and coordinating with the scheduler, the page manager can apply a page management policy to either leave open or close a memory page after an access to a memory location in the memory page based on the scheduling policy of the memory scheduler. Instead of assuming a first row hit, then first-come first-serve (FRFCFS) scheduling policy, a memory page management policy can be applied by the memory controller to optimize memory access times and reduce latency by configuring the page manager to ask the scheduler about the next request to be scheduled before deciding whether to open or close the row buffer. In this way, the page manager and the scheduler can make coordinated decisions to yield low DRAM access latency.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. Some portions of the detailed descriptions provided herein are presented in terms of algorithms and instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

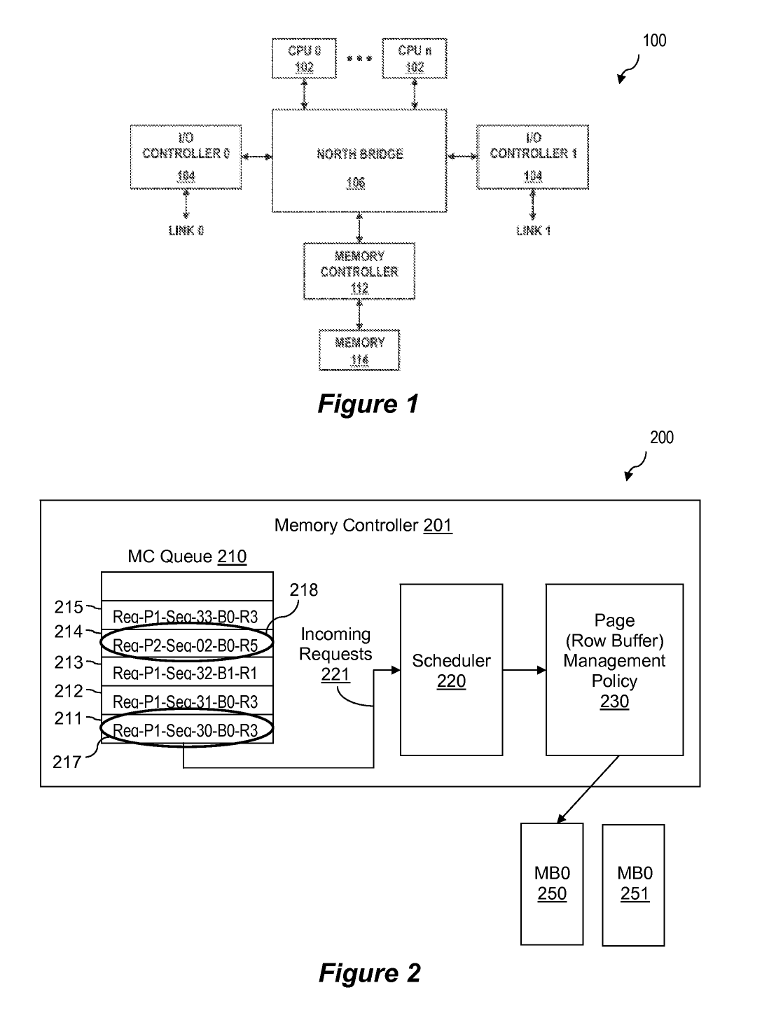

Referring now to FIG. 1, there is shown in simplified block diagram form an example processor system 100 that may be configured according to various embodiments of the present disclosure. As depicted, the system 100 includes one or more central processing units (CPUs) or processing cores 102, one or more input/output (I/O) controllers 104, a Northbridge 106, a memory controller 112, and a memory 114, which includes an application-appropriate amount of dynamic random access memory (DRAM). The system 100 may also include I/O devices (not shown) coupled to the I/O controllers 104. The I/O devices may be, for example, a hard-drive, I/O port, network device, keyboard, mouse, graphics card, etc. In selected embodiments, the memory 114 is a shared system resource that is coupled to the memory controller 112. The memory controller 112 may broadly be considered a resource scheduler. While only two of the CPUs 102 are depicted in the system 100, it will be appreciated that the techniques disclosed herein are broadly applicable to processor systems that include additional or fewer CPUs, each of which may have one or more levels of internal cache. Similarly, while only two I/O controllers 104 are depicted in the system 100, it will be appreciated that the techniques disclosed herein are broadly applicable to processor systems that include any number of I/O controllers.

The memory controller 112 may be, for example, a dynamic random access memory (DRAM) controller, in which case the memory 114 includes multiple DRAM modules. The memory controller 112 may be integrated within the Northbridge 106 or may be located in a different functional block of the processor system 100. The I/O controller(s) 104 may take various forms. For example, the I/O controllers 104 may be HyperTransport controllers. In general, the system 100 includes various devices that read/write information from/to the memory 114. In a typical implementation, the memory 114 is partitioned into a number of different rank/bank pairs, where the rank corresponds to a chip select. For example, a DRAM channel may have four ranks per channel with eight banks per rank, which corresponds to thirty-two independent information states that need to be tracked to choose an incoming request schedule that provides an optimal performance. In selected embodiments, the system 100 may implement more than one DRAM channel and the memory controller 112 may be configured to track less than the maximum number of independent information states.

With reference to FIG. 2, there is depicted in simplified block diagram an example memory system 200 which includes a memory controller unit 201 for managing the flow of data to/from memory 250, 251 using a page management policy 230. In the memory controller 201, a scheduler unit 220 receives incoming requests 221 (e.g., dynamic random access memory (DRAM) read and write requests) which may include an associated rank address, an associated bank address, an associated row address, an associated column address, an indication of whether the request is a read or a write, and associated data (when the incoming request corresponds to a DRAM write). The scheduler 220 translates the incoming requests into DRAM commands and, when the commands correspond to a currently active rank/bank, assigns the DRAM commands to one or more memory controller queues 210 which stores a queue of different memory access requests 211-215 using a memory appropriate communication protocol, such as a first row hit, then first-come first-serve (FRFCFS) scheduling policy. In addition or in the alternative, the scheduler 220 may use other memory scheduling policies, such as an Adaptive per-Thread Least-Attained-Service (ATLAS) memory scheduling algorithm, to reorder memory requests in the opposite way to FRFCFS in order to enhance the overall system performance for multi-program workloads with different memory access characteristics.

The page management policy 230 is configured to reduce the average DRAM access latency by converting row conflicts to row misses. A row conflict is converted to a row miss by closing a DRAM row buffer of a bank that serves a pending memory request before servicing the next memory request to the same bank which accesses a different DRAM row of the bank. However, one of the challenges presented by having different memory scheduling algorithms is that the page manager 230 may operate on the assumption that the scheduler 220 is using an FRFCFS scheduling policy, when in fact the scheduler 220 is using a different scheduling policy (e.g., ATLAS), resulting in degraded system performance.

This is illustrated in the memory system 200 where a scheduling-policy-oblivious row-buffer management policy 230 (which assumes one scheduling policy) works against the scheduler 220 (which uses a different scheduling policy). For example, if page manager 230 assumes a traditional FRFCFS scheduling policy, but in fact the scheduler 220 runs a different memory scheduler, memory performance can be degraded. This results from the fact that ATLAS monitors memory intensiveness of individual applications and prioritizes the memory requests from non-memory-intensive applications which tend to have more instructions between two memory accesses so that it is likely to un-stalls more instructions to serve a memory request from a non-memory-intensive application.

This is illustrated in FIG. 2 where two memory banks 250, 251 (i.e., MB0 and mB1) are accessed by two processes (i.e., P1 and P2), where P1 is more memory intensive than P2 (i.e., more memory requests per second) and thus demands higher memory bandwidth. In the memory controller queue 310, memory access requests 311-315 are stored. For example, the first memory access request 311, Req-P1-Seq-32-B0-R3, is a memory request from process ‘1’ with sequence number ‘32’, and the address requested falls in row (page) ‘3’ in memory bank ‘0’. In operation, the scheduler 220 chooses the request 217 (Req-P1-Seq-30-B0-R3) with sequence number 30 from process P1 and issues the request to MB0 250 to the page manager 230. On receiving the request, the page manager 230 looks into the memory controller queue 210 and observes that there is another request 212 going to the same row (Req-P1-Seq-31-B0-R3) and therefore decides to keep the page open in anticipation of row hit later. However, since ATLAS prioritizes a request from P2 (i.e., a non-memory-intensive core), the next request to be scheduled is request 218 (Req-P2-Seq-02-B0-R5), not request 212 which would be scheduled if it were FRFCFS. As a result, this next request 218 going to Row 5 (R5) causes a row conflict with the current row buffer data (i.e., R3), resulting in worst-case DRAM access latency for the request that is incurred by a scheduling-policy-unaware page manager 230.

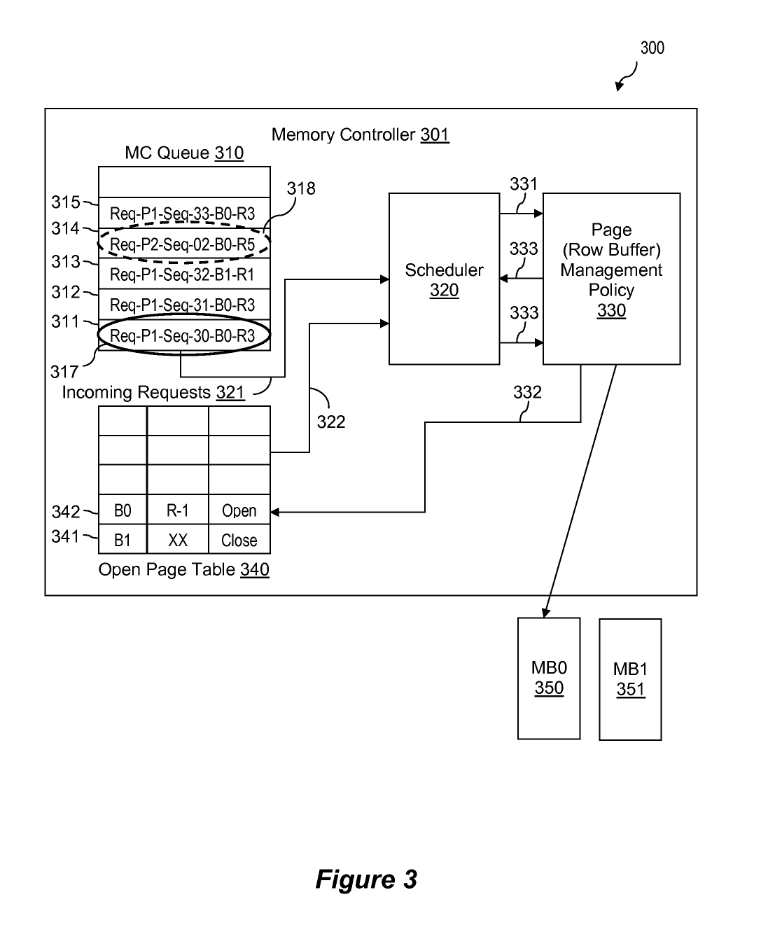

To reduce memory access times and latency, there is disclosed herein a memory management apparatus and method of operation in which the memory controller includes a memory page manager which collaborates with the memory scheduler when determining which memory pages to leave open after a memory access and thereby improve performance by reducing row conflicts that can increase memory access latency. In this regard, FIG. 3 shows in simplified block diagram form an example memory system 300 with memory controller hardware 310 for managing the flow of data to/from memory 350, 351 using an ATLAS scheduler 320, a scheduling-policy-aware DRAM page management policy 330 and an open page table 340 for providing scheduling-policy-aware DRAM page management of the memory 350, 351. In the memory system 300, the open page table 340 is used to track the current states of row buffers, and the memory controller queue 310 contains all pending memory requests 311-315 to be served.

In operation, the scheduler 320 inspects the memory controller queue 310 for incoming requests 321 and inspects the open page table 340 for page status information 322 before selecting a request to be scheduled at the current cycle. The ATLAS scheduler 320 selects a memory request 317 from process P1 to bank MB0 (e.g., Req-Pl-Seq-30-B0-R3), takes the scheduled request 317 out of the memory controller queue 310, and sends 331 the request to the scheduling-policy-aware page manager 330. At this point, the page manager 330 tentatively updates 332 the open page table 340 to indicate that that the row buffer open will be kept open after the scheduled request is handled. In addition, the page manager 330 sends a request 333 to ask the scheduler 320 for the next request to be scheduled among the requests that go to the same bank (e.g., MB0) as the current request scheduled. Based on the tentatively updated open page table 340, the ATLAS scheduler 320 tentatively selects the next request to be scheduled 318 (e.g., Req-P2-Seq-02-B0-R5) using the same scheduling logic as before which prioritizes requests from P2 (i.e., a non-memory-intensive core), except that the request scheduled tentatively in this step is not taken out of the memory controller queue 310. The scheduler 320 then replies or notices 333 the page manager 330 with the next request to be scheduled. With this information about the next scheduled request, the page manager 330 checks if the next request scheduled tentatively is going to incur a row conflict because of the tentative decision of keeping the row buffer open. If a row conflict is indicated, the request 318 scheduled for the current cycle is sent down and the row buffer is closed after the request is handled. If not, the row buffer stays open. For example, after confirming that Req-P2-Seq-02-B0-R5 will cause a row conflict if bank MB0 is kept open, the page manager 330 sends down Req-P1-Seq-30-B0-R3 and closes bank MB0 in the table 340. Later, the next scheduled request 318 (Req-P2-Seq-02-B0-R5) is scheduled and incurs a row miss instead of a row conflict. In this way, the DRAM access latency of Req-P2-Seq-02-B0-R5 is reduced since the scheduler-aware-page (row buffer) management policy 330 can make decisions that avoid row conflicts in the presence of advanced scheduling polices.

To facilitate scheduling policy awareness at the page manager 330, the memory controller circuit 301 uses a DRAM page table 340 that receives incoming requests, e.g., DRAM reads and writes. The page table 340 stores various information that is used by the page manager 330 to determine what command to associate with an incoming request. For example, the page table 340 maintains information as to what memory pages are currently open (i.e., the page table 340 tracks active pages by rank/bank/row and what row is currently assigned to a particular memory bank. The scheduler 320 utilizes the information in the page table 340 to determine what command to associate with an incoming request. For example, if a page at bank 0/row 1 is currently open and the incoming request corresponds to a read of a page at bank 0/row 7, the page at bank 0/row 1 will be closed so that the page at bank/row 7 may be opened. As another example, if a page at bank 0/row 1 is currently open and the incoming request corresponds to a read of a page at bank 0/row 1, the information can be read (using a read command) by providing an appropriate column address without opening or closing a new page.

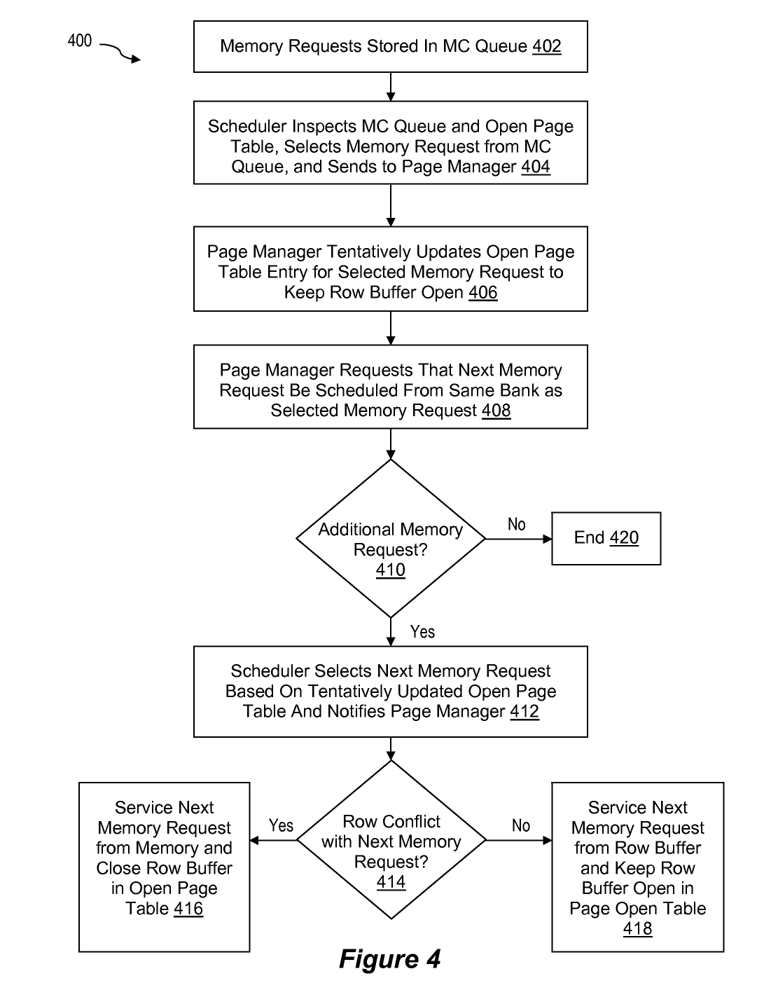

In general, selected embodiments of the memory management apparatus and method of operation disclosed herein make the page manager aware of the scheduling policy so that the page manager collaborates with the scheduler to reduce DRAM access latencies. The framework is general enough to be applied to any advanced scheduling policies at present and in the future without modification. For example, reference is now made to FIG. 4 which illustrates an example process 400 for accessing a memory resource. Without loss of generality, the process 400 is described as a flow diagram sequence flow 400 for the operation of a scheduling-policy-aware DRAM page management. As disclosed, the example sequence 400 is initiated in block 402 as memory access requests are stored in the memory controller queue. At step 404, the scheduler inspects the MC queue and an open page table to select a memory request from the memory queue which is sent to the page manager. In an example embodiment, the scheduler implements an ATLAS scheduling algorithm, though other algorithms may be used, including any non-FRFCFS scheduling policy.

At step 406, the page manager tentatively updates the open page table entry for the selected memory access request to indicate that the row buffer is to be kept open. In this way, the page manager proceeds as if it decided to keep the row buffer open after the scheduled request is handled.

At step 408, the page manager may request the scheduler to schedule the next memory access from the same memory bank as the currently pending memory access request. If there are no more memory access requests to process (negative outcome to decision 410), the process ends (step 420). However, if there are additional memory access requests (affirmative outcome to decision 410), the scheduler selects the next request to be scheduled based on the tentatively updated open page table and notifies the policy manager of the next scheduled request (step 412). In this selection process, the scheduler uses the same scheduling logic for the step 404, except that the request scheduled in step 412 is not taken out of the memory controller queue.

At step 414, the page manager checks if the next tentatively scheduled request is going to incur a row conflict because of the tentative decision to keep the row buffer open. If there is a row conflict (affirmative outcome to decision 414), the request scheduled for the current cycle is sent down and the row buffer is closed after the request is handled (step 415). However, if there is no conflict (negative outcome to decision 414), the row buffer stays open and the next memory request is services from the open buffer (step 418).

By now it will be appreciated that there is disclosed herein a method and circuit device for accessing dynamic random access memory. In the disclosed method and device, memory access requests which include memory addresses are received at a memory controller and stored at a memory controller (MC) queue. A first memory access request is selected from a plurality of memory access requests, removed from the MC queue, and scheduled by inspecting an open page table storing row buffer status information for the plurality of memory access requests and applying a predetermined scheduling policy (e.g., ATLAS) to the plurality of memory access requests. The scheduled first memory access request is sent to a page manager which applies a page management policy for a memory page specified by the first memory access request. The page manager then sends a tentative update to the open page table to indicate that a row buffer at the memory page is to be kept open after the first memory access request is processed. In addition, the page manager sends a request to the scheduler that the next memory access request to be scheduled go to the same memory page as the first memory access request. With this information, a second memory access request is selected from the plurality of memory access requests and scheduled by inspecting the open page table and applying the predetermined scheduling policy to the plurality of memory access requests. The scheduler then notifies the page manager of the scheduled second memory access request so that the page manager can determine if the scheduled second memory access request will incur a row conflict based on the tentative update to the open page table for the memory page. If the page manager determines that the scheduled second memory access request will incur a row conflict, the first memory access request is sent down and an update is sent to the open page table to indicate that the row buffer at the memory page is to be closed after the first memory access request is processed. However, if the page manager determines there will not be a row conflict, the row buffer at the memory page open is kept open after the first memory access request is processed. Subsequently, the scheduler sends the second memory access request to the page manager for applying the page management policy for a memory page specified by the second memory access request.

In other embodiments, there is disclosed herein a memory controller and associated method of operation. As disclosed, the memory controller includes a scheduler that is configured to translate memory transaction requests into respective commands and assign associated ones of the respective commands to a same one of respective command streams by applying a predetermined scheduling policy to the memory transaction requests. The memory controller also includes a memory page table that is configured to track open pages and associated row buffer status information in a memory. In addition, the memory controller includes a page manager for collaborating with the scheduler to determine if a row buffer conflict exists between a next scheduled memory transaction request and a pending memory transaction request based on row buffer status information stored in the memory page table. In operation, the page manager is configured to exchange messages with the scheduler so as to be aware of the predetermined scheduling policy applied by the scheduler. This exchange of messages enables the page manager to tentatively update the memory page table to keep open a row buffer for a page at a predetermined memory bank associated with a pending memory transaction request. As a result, the page manager is configured to apply a leave open page management policy to the memory page table for a row buffer of a page at a predetermined memory bank associated with a pending memory transaction request if there is no row conflict with a next scheduled memory transaction request to the predetermined memory bank. Alternatively, the page manager is configured to instruct the memory page table to close a row buffer of a page at a predetermined memory bank associated with a pending memory transaction request if there is a row conflict with the next scheduled memory transaction request to the predetermined memory bank.

Although the described exemplary embodiments disclosed herein are directed to selected stacked die embodiments and methods for fabricating same, the present invention is not necessarily limited to the example embodiments which illustrate inventive aspects of the present invention that are applicable to a wide variety of memory types, processes and/or designs. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Accordingly, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A memory system, comprising:
a memory controller configured to access memory in response to a memory access request by applying a scheduler-aware page management policy to at least one memory page based in the memory based on row buffer status information for the pending memory access requests scheduled in a current cycle.

2. The memory system of claim 1, where the memory controller comprises:
a memory controller queue for storing pending memory access requests from a plurality of concurrent request streams with varying characteristics;
a scheduler for applying a predetermined scheduling policy to the plurality of concurrent request streams to select a next scheduled memory access request;
an open page table for storing the row buffer status information for the pending memory access requests scheduled in a current cycle; and
a page manager for collaborating with the scheduler to determine if a row conflict exists between the next scheduled memory access request and a pending memory access request based on row buffer status information stored in the open page table.

3. The memory system of claim 2, where the scheduler comprises an Adaptive per-Thread Least-Attained-Service (ATLAS) memory scheduling algorithm.

4. The memory system of claim 2, where the page manager is configured to tentatively update the open page table to keep open a row buffer for a page at a predetermined memory bank associated with a pending memory access request.

5. The memory system of claim 2, where the page manager is configured to apply a leave open page management policy to the open page table for a row buffer of a page at a predetermined memory bank associated with a pending memory access request if there is no row conflict with the next scheduled memory access request to the predetermined memory bank.

6. The memory system of claim 2, where the page manager is configured to instruct the open page table to close a row buffer of a page at a predetermined memory bank associated with a pending memory access request if there is a row conflict with the next scheduled memory access request to the predetermined memory bank.

7. The memory system of claim 2, where the scheduler is configured to tentatively select the next scheduled memory access request without removing the next scheduled memory access request from the memory controller queue.

8. The memory system of claim 2, where the scheduler is configured to notify the page manager of the next scheduled memory access request.

9. A method of accessing dynamic random access memory, comprising:
scheduling a first memory access request from a plurality of memory access requests by inspecting an open page table storing row buffer status information for the plurality of memory access requests and applying a predetermined scheduling policy to the plurality of memory access requests;
sending the first memory access request to a page manager for applying a page management policy for a memory page specified by the first memory access request;
sending a tentative update to the open page table to indicate that a row buffer at the memory page is to be kept open after the first memory access request is processed;
sending a request to the scheduler that the next memory access request to be scheduled go to the same memory page as the first memory access request;
scheduling a second memory access request from the plurality of memory access requests by inspecting the open page table and applying the predetermined scheduling policy to the plurality of memory access requests; and
notifying the page manager of the scheduled second memory access request so that the page manager determines if the scheduled second memory access request will incur a row conflict based on the tentative update to the open page table for the memory page.

10. The method of claim 9, further comprising:
receiving the first memory access request comprising a memory address at a memory controller; and
storing the first memory access request with one or more memory access requests at a memory controller queue.

11. The method of claim 9, where sending the first memory access request comprises removing the first memory access request from a memory controller queue where the plurality of memory access requests are stored.

12. The method of claim 9, further comprising sending the second memory access request to the page manager for applying the page management policy for a memory page specified by the second memory access request.

13. The method of claim 9, further comprising sending the first memory access request down and sending an update to the open page table to indicate that the row buffer at the memory page is to be closed after the first memory access request is processed if the page manager determines that the scheduled second memory access request will incur a row conflict.

14. The method of claim 9, further comprising keeping the row buffer at the memory page open after the first memory access request is processed if the page manager determines that the scheduled second memory access request will not incur a row conflict.

15. The method of claim 9, where the first and second memory access requests are scheduled by applying an Adaptive per-Thread Least-Attained-Service (ATLAS) memory scheduling algorithm.

16. A memory controller, comprising:
a scheduler configured to translate memory transaction requests into respective commands and assign associated ones of the respective commands to a same one of respective command streams by applying a predetermined scheduling policy to the memory transaction requests;
a memory page table configured to track open pages and associated row buffer status information in a memory; and
a page manager for collaborating with the scheduler to determine if a row buffer conflict exists between a next scheduled memory transaction request and a pending memory transaction request based on row buffer status information stored in the memory page table.

17. The memory controller of claim 16, where the page manager is configured to exchange messages with the scheduler so as to be aware of the predetermined scheduling policy applied by the scheduler.

18. The memory controller of claim 16, where the page manager is configured to tentatively update the memory page table to keep open a row buffer for a page at a predetermined memory bank associated with a pending memory transaction request.

19. The memory controller of claim 16, where the page manager is configured to apply a leave open page management policy to the memory page table for a row buffer of a page at a predetermined memory bank associated with a pending memory transaction request if there is no row conflict with a next scheduled memory transaction request to the predetermined memory bank.

20. The memory controller of claim 16, where the page manager is configured to instruct the memory page table to close a row buffer of a page at a predetermined memory bank associated with a pending memory transaction request if there is a row conflict with the next scheduled memory transaction request to the predetermined memory bank.

21. A method comprising:
accessing, via a memory controller, memory in response to a memory access request by applying a scheduler-aware page management policy to at least one memory page based in the memory based on row buffer status information for the pending memory access requests scheduled in a current cycle.
